(19) United States
(12) Patent Application Publication
(10) Pub. No.: US 2015/0185366 A1
(43) Pub. Date: Jul. 2, 2015

(54) OPTICAL THIN-FILM COATING OF A LENS BARREL

(71) Applicant: Genius Electronic Optical Co., Ltd., Taichung City (TW)

(72) Inventors: Matthew Bone, Fremont, CA (US); Wen-Hua Lin, Taichung City (TW)

(73) Assignee: Genius Electronic Optical Co., Ltd., Taichung City (TW)

(21) Appl. No.: 14/141,322

(22) Filed: Dec. 26, 2013

(51) Int. Cl. G02B 1/11; G02B 7/02

(52) U.S. Cl. CPC G02B 1/11; G02B 7/02; G02B 1/115

(57) ABSTRACT

Portions of a lens barrel for an optical imaging system can be coated with an optical thin-film coating to prevent unwanted light, such as flare, from reaching an image sensor. The optical thin-film coating can be a multi-layered structure formed from alternating layers of a low-refractive-index material and a high-refractive-index material. The coating can have low absolute reflectance (e.g., less than 1% across the wavelength range of visible light) and can be applied to a front surface and/or other surfaces of a lens barrel.

### BACKGROUND

The present disclosure relates to optical imaging systems, and more particularly to an optical thin-film coating on a lens barrel unit of an optical imaging system.

Optical imaging systems are commonly incorporated in personal electronic devices such as mobile phones, tablet computers, and the like. These systems include an image sensor responsive to incident light and lens elements to direct and focus light onto the image sensor so as to form an image of an object external to the device in which the optical imaging system is incorporated. Such systems can include multiple lens elements, and a lens barrel can be provided to hold the lens elements in alignment with each other. In some designs, light reflecting off a surface of the lens barrel can pass through the lenses and impinge on the image sensor. This can produce flare and other artifacts that can adversely affect image quality.

### SUMMARY

Certain embodiments of the present invention relate to an optical thin-film coating, a lens barrel, and an optical lens system that can be used in an optical imaging system (e.g., a camera). Portions of the optical lens system, including portions of the lens barrel, can be coated with an optical thin-film coating. According to certain embodiments of the present invention, the optical thin-film coating may include a multi-layered coating structure that has low absolute reflectance of less than 0.5% across the wavelength range of visible light. The optical thin-film coating can be applied to a front surface and/or other surfaces of a lens barrel.

The optical thin-film coating can be formed from alternating layers of a low-refractive-index material and a high-refractive-index material. The coating can reduce the reflectivity of the surface of an object to which the coating is applied. In some embodiments, the surface to which the optical thin-film coating is applied can be a surface of an object such as a lens barrel that is made of a black polycarbonate material. An optical thin-film coating so applied can impart a deeper black color by reducing the amount of light reflected from the polycarbonate surface. The reduced reflection can also reduce stray light entering the lens barrel, thus reducing flare.

Certain embodiments of the present invention relate to a lens barrel, the body of which has an inner surface to accommodate a lens group and a front surface at the front end of the body. Light enters the body through an aperture in the front end. An optical thin-film coating can be applied to the front surface, to a portion of the inner surface near the front surface (e.g., between the front surface and the first lens of the lens group), and/or to the entire inner surface. The optical thin-film coating can include layers of a low-refractive-index material (e.g., a material with lower refractive index than the lens barrel body) alternating with a plurality of layers of a high-refractive-index material (e.g., a material with higher refractive index than the lens barrel body). For example, the low-index material can be silicon dioxide (SiO₂) while the high-index material is titanium dioxide (TiO₂). Other materials can also be used; different low-index layers can be made of different materials, and different high-index layers can be made of different materials. Different layers can have different thicknesses, e.g., such that the optical path length in each layer is a quarter-wavelength of a different representative wavelength within the visible-light spectrum. The top layer can be made of low-index material, and the bottom layer can also be made of low-index material (for an odd number of layers) or high-index material (for an even number of layers). In some embodiments, a surface of the lens barrel can be roughened prior to applying the coating, and this can further reduce reflectance. The coating, which can have a total thickness in a range between 150 nm and 480 nm, can provide a maximum reflectance of less than 2% across wavelengths from 400 nm to 650 nm. In some embodiments, the maximum reflectance can be less than 1% and the average reflectance less than 0.5% across a visible-light spectrum (e.g., wavelengths from about 380 to 760 nm); in some embodiments, the maximum reflectance is less than 0.5% and the average reflectance is less than 0.3%.

The following description, together with the accompanying drawings, will provide a better understanding of the nature and advantages of the claimed invention.

### BRIEF DESCRIPTION OF THE DRAWINGS

FIG. 1 is a cross-sectional view of an imaging device according to an embodiment of the present invention.

FIG. 2 is a cutaway side view of a lens barrel showing surfaces that can be coated according to an embodiment of the present invention.

FIG. 3 is an enlarged cross-sectional view of a portion of the lens barrel showing a coating structure according to an embodiment of the present invention.

FIG. 4 is a graph showing reflectance vs. wavelengths of visible light for an optical thin-film coating according to an embodiment of the present invention.

FIG. 5 is a graph showing reflectance vs. wavelengths of visible light for an optical thin-film coating structure according to another embodiment of the present invention.

### DETAILED DESCRIPTION

It should be understood that the drawings are not drawn to scale, and similar reference numbers are used for representing similar elements. Various embodiments are described herein by way of example, and features described with respect to different embodiments may be combined and interchanged, without departing from the scope or spirit of the present invention.

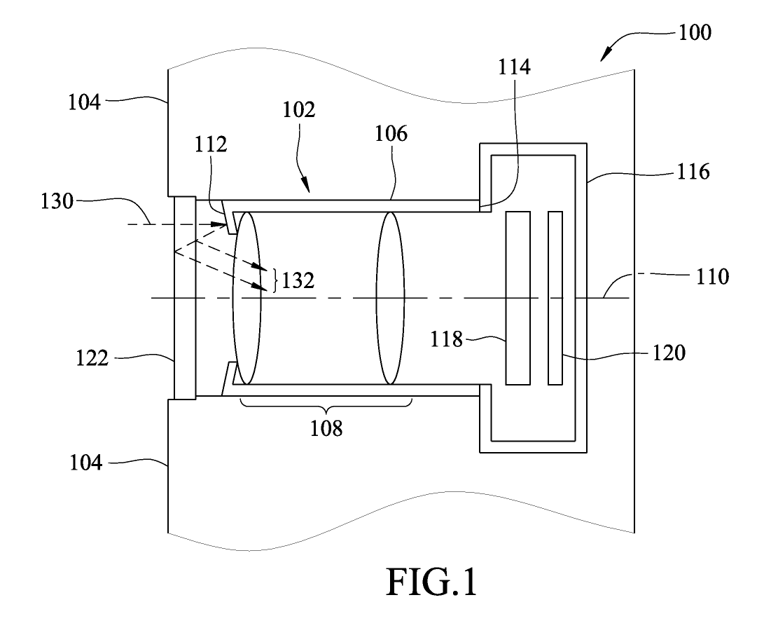

FIG. 1 is a cross-sectional view of an imaging device 100 including a lens barrel unit 102 according to an embodiment of the present invention. Imaging device 100 includes a device body 104 and lens barrel unit 102 that can be mounted within or attached to device body 104. Only a portion of device body 104 is shown; it is to be understood that device body 104 can have any shape or form factor desired (e.g., mobile phone, tablet, laptop computer, camera, etc.).

Lens barrel unit 102 can include a cylindrically shaped lens barrel 106 having a lens group 108 mounted therein along an optical axis 110 between an object-side end 112 and an image-side end 114. Image-side end 114 can be oriented toward a frame 116 that can hold other elements of an optical imaging system, such as IR filter 118 and imaging sensor 120.

Imaging device 100 can also include a lens window 122 disposed in front of the object-side end 112 of lens barrel unit 102. Lens window 122 can have planar surfaces and can be made of glass. Object-side end 112 of lens barrel unit 102 can be visible through lens window 122.

As shown in FIG. 1, light 130 entering imaging device 100 near the periphery of window 122 can be incident on and reflected from object-side end 112 of lens barrel 106. Due to reflectivity of window 122, some of this light can be reflected into lens group 108 as stray light 132; such stray light can cause flare and other degradations in image quality. Some of the light reflected from object-side end 112 can escape through window 122 and affect the appearance of lens barrel 106.

In accordance with some embodiments of the present invention, optical thin-film coatings can be applied to surface 112 and/or other surfaces of lens barrel 106 to reduce the amount of light reflected off these surfaces. Examples of suitable coatings are described below.

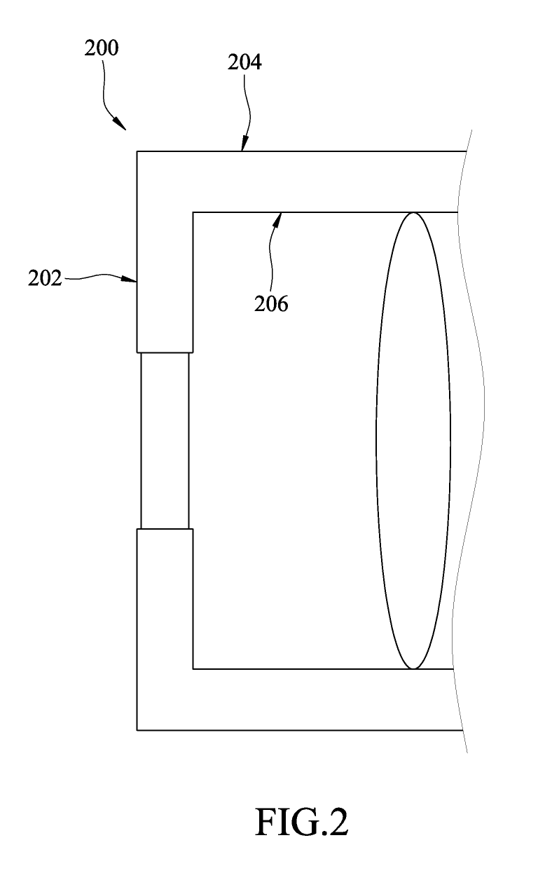

FIG. 2 is a simplified cross-sectional side view showing an object-side end of a lens barrel 200 according to another embodiment of the present invention. Lens barrel 200 can be generally similar to lens barrel 106 of FIG. 1 and can be made of a material such as black polycarbonate. As shown, lens barrel 200 is generally cylindrical and has a front surface 202 perpendicular to the optical axis, a cylindrical outer surface 204, and a cylindrical inner surface 206. It should be noted that the front surface need not be perpendicular to the optical axis or, for that matter, a planar surface.

In accordance with certain embodiments of the present invention, portions of lens barrel 106 of FIG. 1 or lens barrel 200 of FIG. 2 can be coated with an optical thin-film coating. For example, referring to FIG. 2, in some embodiments, a coating can be applied just to front surface 202. In other embodiments, a coating can also be applied to all or part of inner surface 206 to reduce scattered light in lens barrel 112.

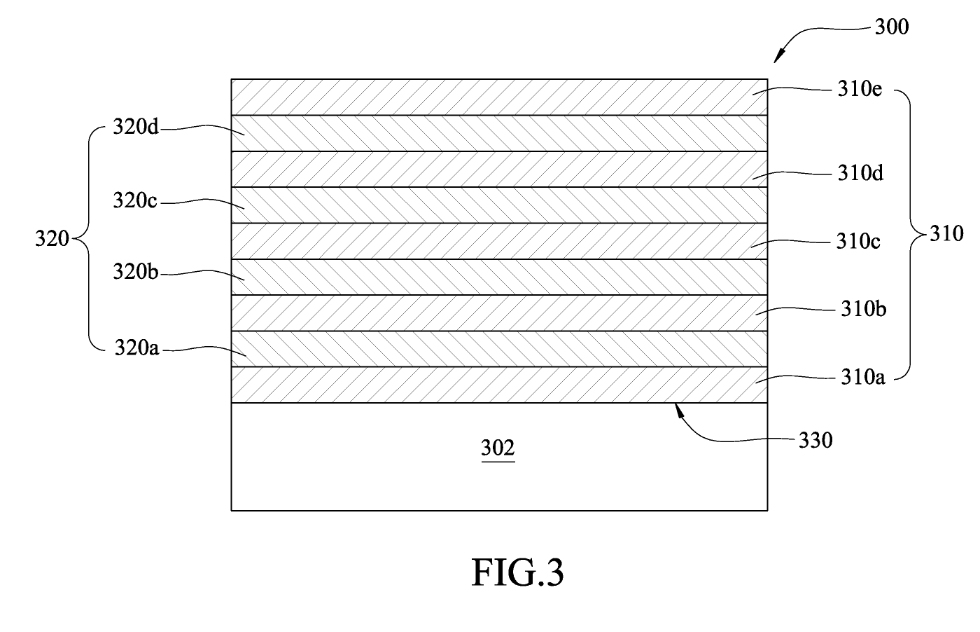

FIG. 3 is a simplified cross-sectional view of a portion of a lens barrel 302 showing a multilayer optical thin-film coating structure 300 according to an embodiment of the present invention. As shown, optical thin-film coating structure 300 may include a number of layers 310 of a material having a low refractive index (referred to as a “low-index material” or “low-refractive-index material”) alternating with layers 320 of a material having a high refractive index (referred to as a “high-index material” or “high-refractive-index material”). As used herein, materials with a refractive index (n) less than the index of the barrel material are considered low-index materials while materials with n greater than the index of the barrel material are considered high-index materials. (For example, for a lens barrel made of polycarbonate, the refractive index of the barrel material would be approximately 1.59 for light at 550 nm.) In some embodiments, the difference (An) between the refractive indexes of the high-index material and the low-index material can be between about 0.5 and 1.5. While a total of nine layers are shown in FIG. 3, a different number of layers can be used.

In some embodiments, prior to applying coating structure 300, a surface 330 of lens barrel 302 to which coating structure 300 is applied can be made rough, which can further reduce reflectance. For example, the surface roughness (Ra) can be in a range between about 0.1 and 1.5 microns, where Ra is the arithmetic average of the absolute values of the surface deviations from a mean. A rough surface 330 can be produced during fabrication of lens barrel 302. For example, if lens barrel 302 is fabricated by injection molding, a surface of the mold can be roughened (e.g., by sanding, etching, grinding, or the like), and this roughness will transfer to surface 330 of lens barrel 302. Alternatively, surface 330 can be roughened after fabrication of lens barrel 302, e.g., by sanding, grinding or other surface roughening processes known in the art.

To further illustrate the nature of coating structure 300, specific examples will now be described with references to particular materials, thicknesses and other properties. It is to be understood that the invention is not limited to these examples.

In one example, coating 300 can include seven layers: a first low-index layer 310a, a second low-index layer 310b, a third low-index layer 310c, and a fourth low-index layer 310d, alternating with a first high-index layer 320a, a second high-index layer 320b, and a third high-index layer 320c.

Table 1 lists the material and thickness of each layer of an example seven-layer optical thin-film coating structure. In this example, silicon dioxide (SiO₂), which has index of refraction n=1.47 (for wavelength λ=550 nm), is used as the low-index material and titanium dioxide (TiO₂), which has n=2.38 for λ=550 nm is used as the high-index material.

TABLE 1

| | layer | | | | | | |
|---|---|---|---|---|---|---|---|
| | 310a | 320a | 310b | 320b | 310c | 320c | 310d |
| material | SiO2 | TiO2 | SiO2 | TiO2 | SiO2 | TiO2 | SiO2 |
| Thickness | 184 | 15 | 28 | 67 | 8 | 30 | 91 |
| (nm) | | | | | | | |

In some embodiments, the thickness of each layer is chosen such that an optical thickness of the layer (physical thickness multiplied by refractive index) is equal to one quarter of a different representative wavelength selected from the visible-light spectrum.

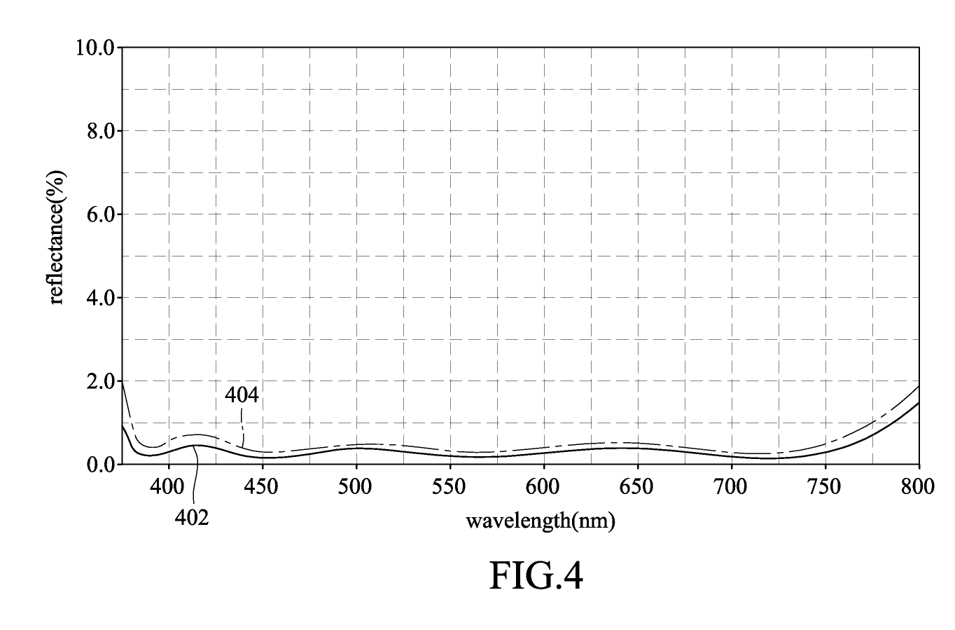

In this example, the total thickness of optical thin-film coating 300 is about 423 nm. This coating can enhance the black or dark color of the lens barrel to a deeper black color. FIG. 4 is a graph showing reflectance vs. wavelengths of visible light for an optical thin-film coating structure formed according to Table 1. Line 402 shows the reflectance based on the parameters specified in Table 1; line 404 shows the effect of a 2% process variation. As shown, the maximum reflectance is less than 0.5% and the average reflectance is less than 0.3% across the visible spectrum (wavelengths in the range between 380 nm and 760 nm).

In another example, optical thin-film coating structure 300 can include nine layers: a first low-index layer 310a, a second low-index layer 310b, a third low-index layer 310c, a fourth low-index layer 310d, and a fifth low-index layer 310e, alternating with a first high-index layer 320a, a second high-index layer 320b, a third high-index layer 320c, and a fourth high-index layer 320d.

Table 2 shows the material and the thickness of each layer of an example nine-layer optical thin-film coating structure. In this example, SiO₂ and TiO₂ are again used as the low-index material and high-index material.

TABLE 2

| | layer | | | | | | | | |
|---|---|---|---|---|---|---|---|---|---|
| | 310a | 320a | 310b | 320b | 310c | 320c | 310d | 320c | 310e |
| material | SiO2 | TiO2 | SiO2 | TiO2 | SiO2 | TiO2 | SiO2 | TiO2 | SiO2 |
| Thickness | 177 | 9 | 15 | 8 | 18 | 64 | 8 | 30 | 91 |
| (nm) | | | | | | | | | |

As in the first example, the thicknesses of the layers in this example are each chosen such that the optical path length (physical thickness times refractive index) is equal to a quarter of a wavelength for light of a given wavelength, with different wavelengths used for different layers.

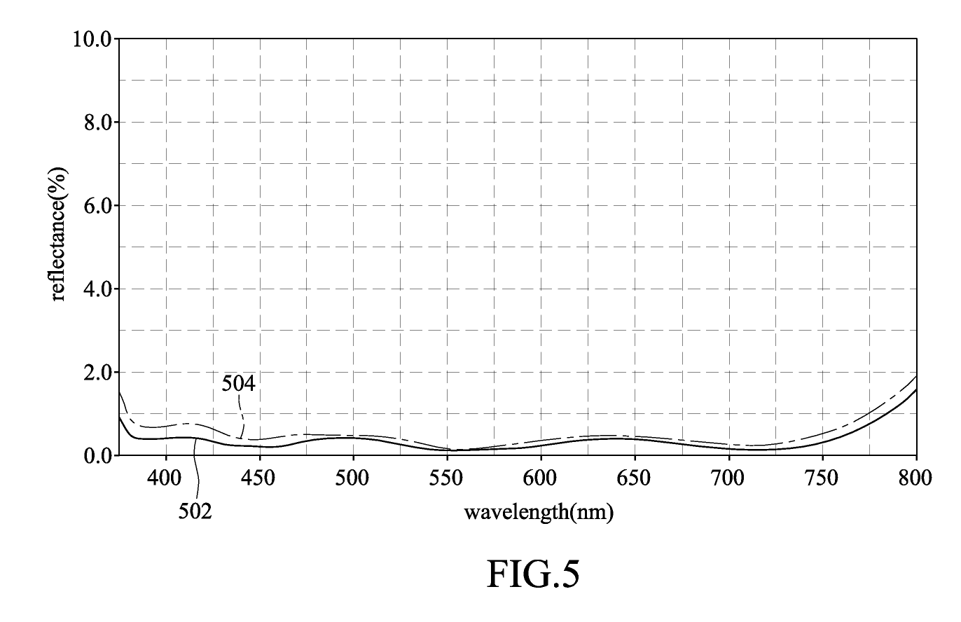

In this example, the total thickness of coating 300 is about 420 nm. The coating in this example also can enhance the black or dark color of the lens barrel to a deeper black color. FIG. 5 is a graph showing reflectance vs. wavelengths of visible light for an optical thin-film coating structure formed according to Table 2. Line 502 shows the reflectance based on the parameters specified in Table 2; line 504 shows the effect of a 2% process variation. As shown, the maximum reflectance is less than 0.5% and the average reflectance is less than 0.3% across the visible spectrum.

In a third example, optical thin-film coating structure 300 can include six layers: a first high-index layer 320a, a second high-index layer 320b, and a third high-index layer 320c, alternating with a first low-index layer 310a, a second low-index layer 310b, and a third low-index layer 310c. In this example, high-index layer 320a is closest to the barrel surface.

Table 3 shows the material and the thickness of each layer of an example six-layer optical thin-film coating structure. In this example, SiO₂ and TiO₂ are again used as the low-index material and high-index material.

TABLE 3

| | layer | | | | | |
|---|---|---|---|---|---|---|
| | 320a | 310a | 320b | 310b | 320c | 310c |
| material | TiO2 | SiO2 | TiO2 | SiO2 | TiO2 | SiO2 |
| Thickness | 13 | 33 | 47 | 15 | 35 | 95 |
| (nm) | | | | | | |

In this example, the total thickness of coating 300 is about 250 nm. The coating in this example also can enhance the black or dark color of the lens barrel to a deeper black color. The maximum reflectance is less than 1% and the average reflectance is less than 0.5% across the visible spectrum.

The coatings described above can be varied. For example, although the materials SiO₂ and TiO₂ are identified as examples of low-index and high-index materials, other materials such as Ag (n=0.12, all values at λ=587 nm), Al (n=1.20), Na₃AlF₆(n=1.34), MgF₂(n=1.37), Al₂O₃ (n=1.77), Y₂O₃ (n=1.93), HfO₂(n=1.92), ZrO₂ (n=2.21), Ta₂O₅ (n=1.80), glass materials, polycarbonates, and the like can also be used. Different high-index materials (or low-index materials) can be used for different high-index layers (or low-index layers) within the same optical thin-film coating.

In the first two examples described above, the optical thin-film coating includes an odd number of layers, and the bottom layer (in contact with the lens barrel surface) and top layer of the coating are both made of a low-index material. In the third example, an even number of layers is used, with the bottom layer being made of a high-index material, and the top layer being made of a low-index material. Other arrangements are also possible. For example, with an odd number of layers, the bottom and top layers can both be made of high-index material; with an even number of layers, the bottom layer can be made of a low-index material while the top layer is made of a high-index material.

In some embodiments, the total thickness of the optical thin-film coating structure (sum of layer thicknesses) is in the range between 150 nm and 480 nm. In some embodiments, as noted above, the surface of the lens barrel to which the optical thin-film coating is applied can have a surface roughness (Ra) in the range between 0.1 and 1.5 microns, and this can further reduce reflectance of the coated surface.

As described above, a surface of a lens barrel coated with an optical thin-film coating can have very low surface reflectance. Reducing reflectance in this manner can reduce the amount of stray light that enters the lens barrel, which can improve image quality. It can also impart a desirable deep black color to the front surface of the barrel, which may be visible in a finished electronic device, and this can be a desirable esthetic effect. The optical thin-film coating can be quite thin (less than half a micron in some embodiments), which can be significant in miniature optical systems such as those in mobile phones and other personal device where space is at a premium. Further, the thickness of the optical thin-film coating is controllable to a finer precision than is possible with other options for reducing reflectance (e.g., paint).

The optical thin-film coatings described above can suppress light reflection through various physical effects such as destructive interference (due to the quarter-wave thickness of the layers) and improved index-matching between air and the lens barrel material (e.g., the refractive indexes of at least one of the thin-film layers can be intermediate between the indexes of air and typical black polycarbonate materials). As described above, an optical thin-film coating can produce fairly uniform reflectance across the visible spectrum. In some embodiments, the number, thickness, and/or composition of the layers of the coating can be tuned to selectively provide somewhat higher reflectance at certain wavelengths to give the black surface an undertone of a desired hue (e.g., bluish black, greenish black, purplish black, and so on). To the extent that the layer thicknesses can be controlled during manufacture, the undertone hue can be consistent across a large number of lens barrels.

While the invention has been described with reference to specific embodiments, it is to be understood that variations and modifications are possible. For example, an optical thin-film coating can include any number of layers, and layers of different materials can be combined. In various embodiments, an optical thin-film coating can be applied to the front surface of the lens barrel (e.g., a surface that surrounds a front aperture through which light enters the lens barrel), to a portion of an inner cylindrical surface of the lens barrel (e.g., in front of the first lens of the lens group within the barrel), and/or to the entire inner surface of the lens barrel.

The optical thin-film coating can provide a significant reduction in reflectance on any surface to which it is applied. For example, for typical lens barrel materials (e.g., black polycarbonate), the barrel without the optical thin-film coating would have a reflectance value of about 4%. In some embodiments, a lens barrel coated with an optical thin-film coating can have a maximum (absolute) reflectance value of less than 3% across wavelengths from 380 nm to 800 nm and an average reflectance of less than 0.5% across wavelengths from 380 nm to 750 nm. In other embodiments, a lens barrel coated with an optical thin-film coating can have a maximum reflectance of less than 1% across wavelengths from 380 nm to 760 nm and average reflectance of less than 0.3% across wavelengths from 380 nm to 750 nm. In still other embodiments, a lens barrel coated with an optical thin-film coating can have a maximum reflectance of 0.5% and an average reflectance value of less than 0.3% for wavelengths in the range between 390 nm and 740 nm. In still other embodiments, a lens barrel coated with an optical thin-film coating can have a maximum reflectance of less than 2% across wavelengths from 400 nm to 650 nm. Such reduced reflectance can provide a deeper black color to the lens barrel. This can provide an esthetically pleasing effect and can also reduce stray light in the images produced by an optical imaging system that incorporates the lens barrel.

Thus, although the invention has been described with respect to specific embodiments, it will be appreciated that the invention is intended to cover all modifications and equivalents within the scope of the following claims.

1. A lens barrel comprising:
a body having an inner surface and a front surface at a front end of the body, the front surface having an aperture therein to allow light to enter the body; and
an optical thin-film coating disposed on at least a portion of the body, the portion of the body on which the optical thin film coating is disposed having a reflectance of less than 2% across wavelengths from 400 nm to 650 nm.

2-3. (canceled)

4. The lens barrel of claim 1 wherein the optical thin-film coating is disposed on a portion of the body that has a surface roughness (Ra) in a range between 0.1 and 1.5 microns.

5. The lens barrel of claim 1 wherein the optical thin-film coating is disposed on at least the front surface of the body.

6. The lens barrel of claim 1 wherein the optical thin-film coating is disposed on at least a portion of the inner surface of the body.

7-10. (canceled)

11. The lens barrel of claim 1 wherein the optical thin-film coating has a total thickness in a range between 150 nm and 480 nm.

12. A lens module comprising:
a lens barrel body having an inner surface and a front surface at a front end of the lens barrel body, the front surface having an aperture therein to allow light to enter the lens barrel body;
a lens group disposed within the lens barrel body; and
an optical thin-film coating disposed on at least a portion of the lens barrel body, the portion of the body on which the optical thin film coating is disposed having a reflectance of less than 3% across wavelengths from 400 nm to 650 nm.

13. (canceled)

14. The lens module of claim 12 wherein the optical thin-film coating is disposed on at least the front surface of the lens barrel body.

15. The lens module of claim 12 wherein the optical thin-film coating is disposed on at least a portion of the inner surface of the lens barrel body.

16-19. (canceled)

20. The lens module of claim 12 wherein a total thickness of the optical thin-film coating is in a range between 150 nm and 480 nm.

21. The lens barrel of claim 1 wherein the optical thin film coating includes a first layer disposed on the body and a second layer disposed on the first layer, a refractive index of the first layer being higher than a refractive index of the second layer.

22. The lens barrel of claim 1 wherein the optical thin film coating includes a first layer disposed on the body and a second layer disposed on the first layer, a refractive index of the first layer being higher than a refractive index of the body, and the refractive index of the body being higher than a refractive index of the second layer.

23. The lens barrel of claim 1 wherein the optical thin film coating provides a maximum reflectance of less than 1% across wavelengths from 500 nm to 650 nm.

24. The lens barrel of claim 1 wherein the optical thin film coating provides an average reflectance of less than 1% across wavelengths from 500 nm to 650 nm.

25. The lens module of claim 12 wherein the optical thin film coating includes a first layer disposed on the body and a second layer disposed on the first layer, a refractive index of the first layer being higher than a refractive index of the second layer.

26. The lens module of claim 12 wherein the optical thin film coating includes a first layer disposed on the body and a second layer disposed on the first layer, a refractive index of the first layer being higher than a refractive index of the body, and the refractive index of the body being higher than a refractive index of the second layer.

27. The lens module of claim 12 wherein the optical thin film coating provides a maximum reflectance of less than 1% across wavelengths from 500 nm to 650 nm.

28. The lens module of claim 12 wherein the optical thin film coating provides an average reflectance of less than 1% across wavelengths from 500 nm to 650 nm.

29. The lens module of claim 12 wherein the optical thin film coating comprises at least three layers of a first material alternating with at least three layers of a second material.

30. The lens module of claim 12 wherein a difference between a refractive index of the first material and a refractive index of the second material is less than 1.5.

31. The lens module of claim 12 wherein the front surface of the lens barrel has a surface roughness (Ra) in a range between 0.1 and 1.5 microns.
